(19) United States
(12) Patent Application Publication
(10) Pub. No.: US 2012/0267825 A1
(43) Pub. Date: Oct. 25, 2012

(54) METHOD OF MANUFACTURING INERTIAL SENSOR

(75) Inventors: Sung Jun LEE, Goyang-si (KR); Won Kyu JEUNG, Seoul (KR)

(73) Assignee: SAMSUNG ELECTRO-MECHANICS CO., LTD., Gyunggi-do (KR)

(21) Appl. No.: 13/184,564

(22) Filed: Jul. 17, 2011

(30) Foreign Application Priority Data
Apr. 20, 2011 (KR) 10-2011-0036962

(51) Int. Cl. B29C 70/00

(52) U.S. Cl. 264/259

(57) ABSTRACT

The method of manufacturing an inertial sensor includes: (A) disposing a first mold 120 and a second mold 125 on both surfaces of a predetermined region R in a plate-shaped membrane 110, (B) forming a mass body 130, a post 140, and an upper cap 150 through a plating process or a filling process, (C) disposing a third mold 160 on an exposed surface of the first mold 120 and the mass body 130, and (D) forming a lower cap 170 through the plating process or the filling process. Since the mass body 130 is made of metal by a plating process or a filling process, the density of the mass body 130 may be increased and the mass body 130 may be formed to have a structure of a high aspect ratio, thereby improving the sensitivity of the inertial sensor 100.

### CROSS REFERENCE TO RELATED APPLICATION

This application claims the benefit of Korean Patent Application No. 10-2011-0036962, filed on Apr. 20, 2011, entitled “Method Of Manufacturing Inertial Sensor” which is hereby incorporated by reference in its entirety into this application.

### BACKGROUND OF THE INVENTION

1. Technical Field

The present invention relates to a method of manufacturing an inertial sensor.

2. Description of the Related Art

Recently, an inertial sensor has been used in various fields, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The inertial sensor generally adopts a configuration in which a mass body is bonded to a flexible substrate such as a membrane, or the like, so as to measure acceleration and angular velocity. Through the configuration, the inertial sensor may calculate the acceleration by measuring inertial force applied to the mass body and may calculate the angular velocity by measuring Coriolis force applied to the mass body.

In detail, a process of measuring the acceleration and the angular velocity by using the inertial sensor is as follows. First, the acceleration may be implemented by Newton's law of motion “F=ma”, where “F” represents inertial force applied to the mass body, “m” represents a mass of the mass body, and “a” is acceleration to be measured. Therefore, the acceleration a may be obtained by detecting the force F applied to the mass body and dividing the detected force F by the mass m of the mass body that is a predetermined value. Further, the angular velocity may be obtained by Coriolis force “F=2mΩ·v”, where “F” represents the Coriolis force applied to the mass body, “m” represents the mass of the mass body, “Ω” represents the angular velocity to be measured, and “v” represents the motion velocity of the mass body. Among others, since the motion velocity V of the mass body and the mass m of the mass body are known in advance, the angular velocity Ω may be obtained by detecting the Coriolis force (F) applied to the mass body.

As described above, when the acceleration a is measured by the inertial sensor, the mass body may be displaced by the inertial force F. In addition, when the angular velocity Ω is measured by the inertial sensor, the mass body is vibrated by the motion velocity v. As described above, in order to measure the acceleration a or the angular velocity Ω, the movement of the mass body is essential and the mass body may be formed to have a large density and a structure of a high aspect ratio, in order to increase the sensitivity of the inertial sensor.

However, in the case of the method of manufacturing an inertial sensor according to the prior art, the mass body is formed by optionally etching a silicon substrate such as silicon on insulator (SOI). Therefore, since it is difficult to form the mass body to have a relatively small density and the mass body to have a structure of a high aspect ratio, such that the sensitivity of the inertial sensor may be degraded. In addition, the silicon substrate such as SOI, or the like, is expensive, such that it may be difficult to secure a competitive price.

### SUMMARY OF THE INVENTION

The present invention has been made in an effort to provide a method of manufacturing an inertial sensor capable of increasing a density of a mass body and forming a mass body having a structure of a high aspect ratio, by forming the mass body through a plating process or a filling process.

According to a preferred embodiment of the present invention, there is provided a method of manufacturing an inertial sensor, including: (A) disposing a first mold at one surface of a predetermined region so as to expose an edge and a central portion of one surface of the predetermined region in a plate-shaped membrane; (B) forming a mass body at the central portion of one surface of the predetermined region exposed from the first mold and forming a post at an edge of one surface of the predetermined region through a plating process or a filling process; and (C) removing the first mold.

At the step (A), a second mold may be disposed at the other surface of the predetermined region so as to expose an edge of the other surface of the predetermined region in the membrane, and at the step (B), an upper cap surrounding the second mold may be formed by extending from the edge of the other surface of the predetermined region exposed from the second mold to the exposed surface at the second mold through the plating process or the filling process, and at the step (C), the second mold may be removed.

The method may further include: after the step (B), disposing a third mold at the exposed surface of the first mold and the mass body so as to expose the post; and forming a lower cap surrounding the third mold by extending from the post exposed from the third mold to the exposed surface of the third mold through the plating process or the filling process, wherein at the step (C), the third mold may be removed.

At the step (A), the first mold may be applied to one surface of the predetermined region and then, patterning may be made by exposure and development, so as to expose the edge and the central portion of one surface of the predetermined region.

At the step (A), the second mold may be applied to the other surface of the predetermined region and then, patterning may be made by exposure and development, so as to expose the edge of other surface of the predetermined region.

At the disposing of the third mold, the third mold may be applied to the exposed surface of the post, the first mold and the mass body and then, patterning may be made by exposure and development so as to expose the post.

At the step (B), when the mass body and the post are formed by the plating process, prior to the step (B), a seed layer may be formed at the central portion of one surface of the predetermined region exposed from the first mold, the edge of one surface of the predetermined region and the side of the first mold.

At the step (B), when the upper cap is formed by the plating process, prior to the step (B), a seed layer may be formed at the edge of the other surface of the predetermined region that are exposed from the second mold and the exposed surface of the second mold.

At the step (B), when the mass body and the post are formed by the filling process, the step (B) may perform the filling process using a metal paste.

At the step (B), when the upper cap is formed by the filling process, the step (B) may perform the filling process using the metal paste.

At the forming of the lower cap, when the lower cap is formed by the filling process, the forming of the lower cap may perform the filling process using the metal paste.

At the step (C), the first mold may be removed by a wet removing method or plasma ashing.

At the step (c), the second mold may be removed by the wet removing method or the plasma ashing.

At the step (c), the third mold may be removed by the wet removing method or the plasma ashing.

Prior to the step (A), the method may further include forming a piezoelectric body and an electrode at the other surface of the predetermined region in the membrane.

The method may further include, after the step (C), partitioning the membrane along a boundary of the predetermined region, wherein at the step (A), the membrane is partitioned into a plurality of predetermined regions.

### BRIEF DESCRIPTION OF THE DRAWINGS

FIGS. 1 to 12 are process cross-sectional views showing a method of manufacturing an inertial sensor according to a preferred embodiment of the present invention in a process order;

FIG. 13 is a plan view of a predetermined region of the inertial sensor shown in FIG. 1;

FIG. 14 is a plan view of a predetermined region of the inertial sensor shown in FIG. 2;

FIGS. 15A and 15B are a plan view and a bottom view of the predetermined region of the inertial sensor shown in FIG. 5;

FIGS. 16A and 16B are a plan view and a bottom view of the predetermined region of the inertial sensor shown in FIG. 6A;

FIG. 17 is a bottom view of the predetermined region of the inertial sensor shown in FIG. 9;

FIG. 18 is a bottom view of the predetermined region of the inertial sensor shown in FIG. 10; and

FIG. 19 is a cross-sectional view of the inertial sensor according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second” and so on are used to distinguish one element from another element, and the elements are not defined by the above terms.

Hereinafter, preferred embodiments of the present invention will be described in detail with reference to the accompanying drawings.

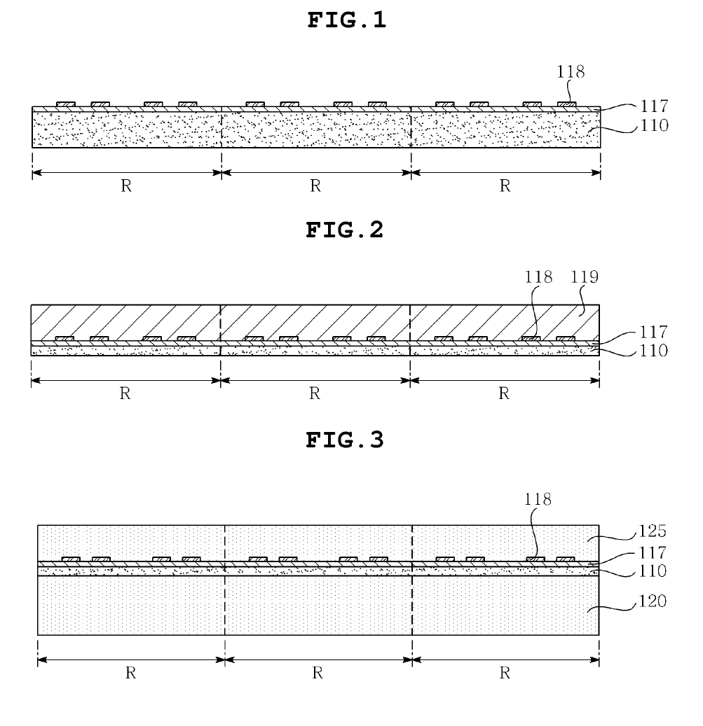

FIGS. 1 to 12 are process cross-sectional views showing a method of manufacturing an inertial sensor according to a preferred embodiment of the present invention in a process order.

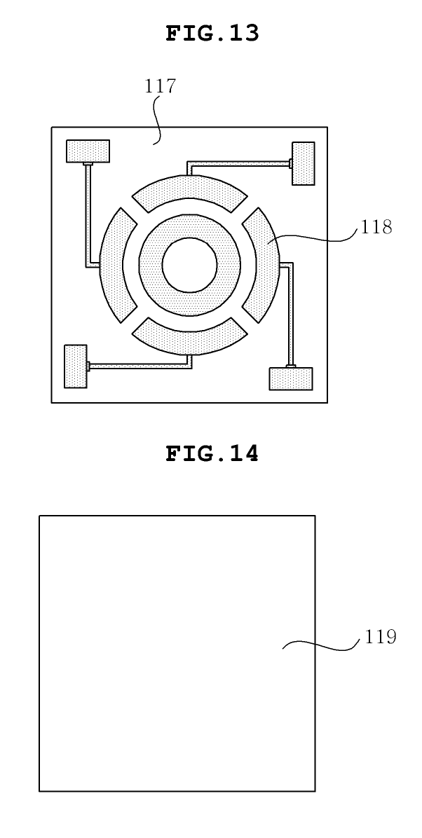

As shown in FIGS. 1 to 12, a method of manufacturing an inertial sensor 100 according to a preferred embodiment of the present invention may be configured to include (A) disposing a first mold 120 and a second mold 125 on both surfaces of a predetermined region R in a plate-shaped membrane 110, (B) forming a mass body 130, a post 140, and an upper cap 150 through a plating process or a filling process, (C) disposing a third mold 160 on an exposed surface of the first mold 120 and the mass body 130, and (D) forming a lower cap 170 through the plating process or the filling process. First, as shown in FIGS. 1 and 13, a process of forming a piezoelectric body 117 and an electrode 118 of the other surface (a surface facing the surface on which the first mold 120 (FIG. 3) is disposed) of a predetermined region R in the membrane 110 is performed. In detail, the other surface of the predetermined region R in the membrane 110 may be formed with the piezoelectric body 117 such as lead zirconate titanate (PZT), or the like, and the piezoelectric body 117 may be formed with the electrode 118 by deposition. In the above Figures, the electrode 118 is formed only on a top surface of the piezoelectric body 117 but may also be formed on a bottom surface of the piezoelectric body 117. Finally, the piezoelectric body 117 and the electrode 118 serve to detect the displacement of the mass body 130 by using a piezoelectric effect or vibrate the mass body 130 by using a reverse piezoelectric effect.

Meanwhile, the predetermined region R is a region in which a single inertial sensor 100 is finally formed. The single membrane 110 may be partitioned into the plurality of predetermined regions R since the plurality of inertial sensors 100 are generally manufactured by using the single membrane 110. However, when the single inertial sensor 100 is manufactured by using the single membrane 110, the overall membrane 110 is partitioned into the single predetermined region R.

Next, as shown in FIG. 2, a thinning process of reducing a thickness of the membrane 110 is performed. In detail, the thickness of the membrane 110 may be reduced by performing a chemical mechanical polishing (CMP) process or an etching process on one surface of the membrane 110. The CMP process is to thin the membrane 110 by combining a mechanical polishing effect using an abrasive and a chemical polishing effect using acid/base solutions. However, when the thickness of the first membrane 110 is the same as the finally necessary thickness, the present process may be omitted.

Meanwhile, in order to prevent the piezoelectric body 117 and the electrode 118 from being damaged during the thinning process of reducing the thickness of the membrane 110, a passivation layer 119 may be formed on the other surface of the membrane 110 so as to protect the piezoelectric body 117 and the electrode 118 (see FIGS. 2 and 14). However, when the thinning process of the membrane 110 ends, the passivation layer 119 is removed since its own role completes.

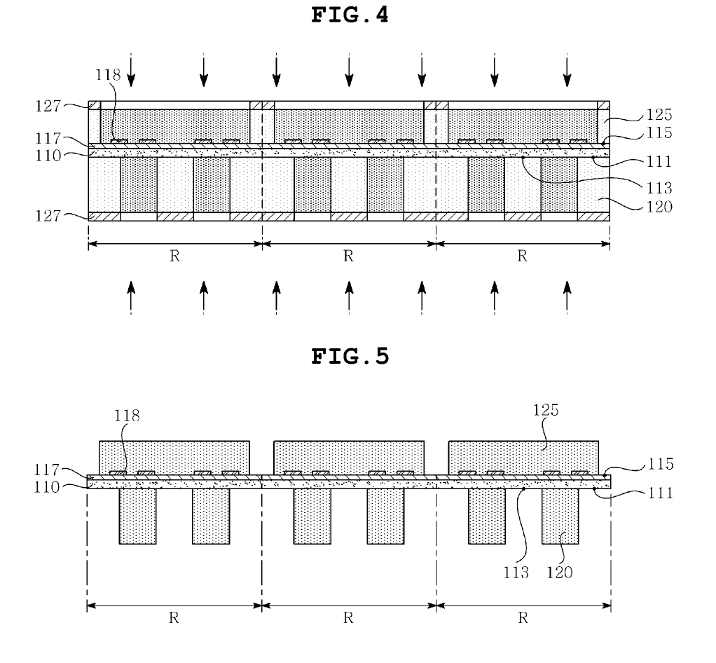

Next, as shown in FIGS. 3 and 4, a process of exposing the first mold 120 and the second mold 125 so as to be optionally hardened is performed after the first mold 120 is applied to one surface of the predetermined region R in the membrane 110 and the second mold 125 is applied to the other surface of the predetermined region R in the membrane 110. In this case, the first mold 120 and the second mold 125 may use a photoresist having photosensitivity. In detail, SU-8 or polydimethylsiloxane (PDMS) having a relatively thick thickness may be used. The present process first applies the first mold 120 and the second mold 125 to both surfaces of the predetermined region R in the membrane 110 and a baking process of removing a solvent within the first mold 120 and the second mold 125 is performed (see FIG. 3). Thereafter, the first mold 120 and the second mold 125 are optionally hardened by closely contacting an artwork film 127 to the first mold 120 and the second mold 125 and exposing them to ultraviolet rays (arrow) (see FIG. 4). During the following process, an edge 111 and a central portion 113 of one surface of the predetermined region R in the membrane 110 is exposed and an edge 115 of the other surface of the predetermined region R in the membrane 110 is exposed. Therefore, during the present process, only the portion corresponding between the edge 111 and the central portion 113 of one surface of the predetermined region R in the first mold 120 and the portion corresponding to a portion other than the edge 115 of the other surface of the predetermined region R in the second mold 125 are optionally hardened.

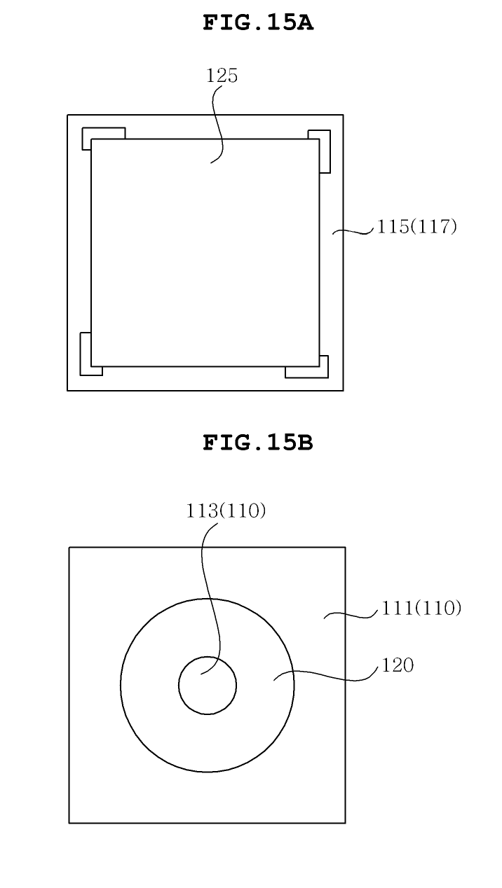

Next, as shown in FIGS. 5 and 15, a process of patterning the first mold 120 by a development so as to expose the edge 111 and the central portion 113 of one surface of the predetermined region R in the membrane 110 and patterning the second mold 125 by a development so as to expose the edge 115 of the other surface of the predetermined region

R in the membrane 110 is performed. During the previous process, the first mold 120 and the second mold 125 are optionally hardened. Therefore, when the portion that is not hardened in the first mold 120 and the second mold 125 is removed by being dissolved with a developer such as sodium carbonate, potassium carbonate, or the like, the first mold 120 and the second mold 125 may be patterned. In this case, the first mold 120 may be formed in a hollow-type cylindrical shape (see FIG. 15B), but is only an example. Therefore, the first mold 120 may be formed in various shapes according to the shape of the mass body 130 and the post 140 to be formed. In addition, the second mold 125 may also be formed in a square pillar (see FIG. 15A), but is only an example. Therefore, the second mold 125 may be formed in various shapes according to the shape of the upper cap 150 to be formed.

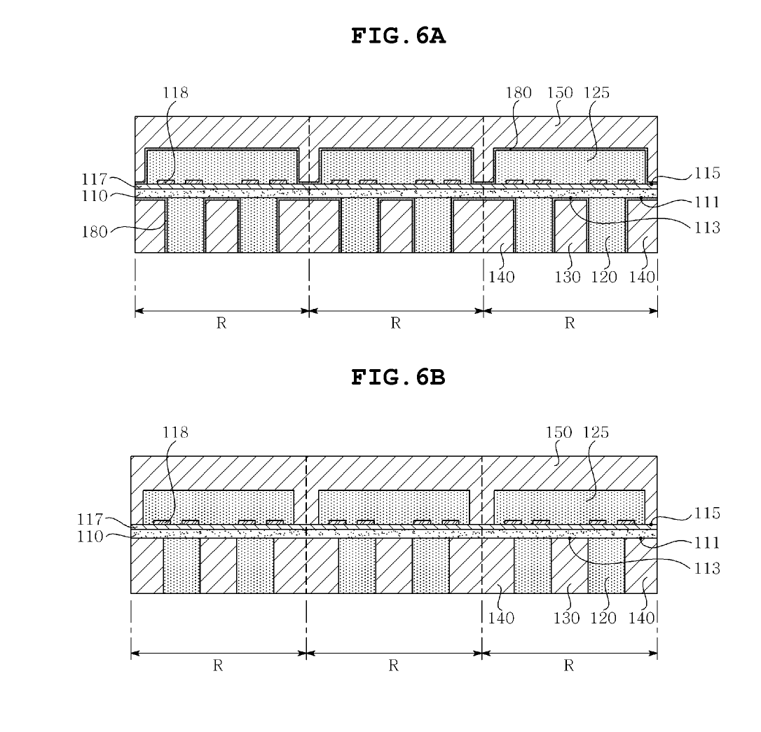

Next, as shown in FIGS. 6A and 6B, a process of forming the mass body 130, the post 140, and the upper cap 150 through the plating process or the filling process is performed.

In detail, as shown in FIG. 6A, the mass body 130, the post 140, and the upper cap 150 may be formed by the plating process. Meanwhile, in order to give the conductivity prior to performing the plating process, a seed layer 180 may be formed. In this case, the seed layer 180 may be formed by a thin film forming method such as a sputtering process, a chemical vapor deposition (CVD) process, or the like. In this case, the seed layer 180 is formed along the central portion 113 of one surface of the membrane 110 exposed from the first mold 120 and the edge 111 of one surface of the membrane 110, the edge 115 on the side of the first mold 120 and the other surface of the membrane exposed from the second mold 125, and the exposed surface of the second mold 125.

After the seed layer 180 is formed, the mass body 130 is formed at the central portion 113 on the one surface of the membrane 110 exposed from the first mold 120 and the post 140 is formed at the edge 111 of one surface of the membrane 110, by performing the plating process using the seed layer 180 as a lead-in wire. In this case, the thickness of the mass body 130 and the post 140 may be equal to or thinner than the thickness of the first mold 120 so that the plating layer does not surround the first mold 120. In addition, the upper cap 150 is formed to extend from the edge 115 of the other surface of the membrane 110 to the exposed surface of the second mold 125 by performing the plating process using the seed layer 180 as the lead-in wire. That is, when the upper cap 150 is formed, the plating process is performed so as to make the upper cap 150 thicker than the thickness of the second mold 125, such that the second mold 125 is completely surrounded with the plating layer. The plating process may be performed using copper (Cu), gold (Au), nickel (Ni), silver (Ag), aluminum (Al), or a combination thereof.

In addition, as shown in FIG. 6B, the mass body 130, the post 140, and the upper cap 150 may be formed by the filling process. In this case, the filling process is performed by filling a metal paste. That is, the mass body 130 is formed at the central portion 113 on the one surface of the membrane 110 exposed from the first mold 120 and the post 140 is formed at the edge 111 of one surface of the membrane 110, by filling the metal paste. In this case, the thickness of the mass body 130 and the post 140 may be equal to or thinner than the thickness of the first mold 120 so that the metal paste does not surround the first mold 120. In addition, the upper cap 150 is formed to extend from the edge 115 of the other surface of the membrane 110 to the exposed surface of the second mold 125 by filling the metal paste. That is, when the upper cap 150 is formed, the filling process is performed so as to make the upper cap 150 thicker than the thickness of the second mold 125, such that the second mold 125 is completely surrounded with the metal paste. In this case, the metal paste may include copper (Cu), nickel (Ni), silver (Ag), aluminum (Al), zinc (Zn) or a combination thereof. The following process is shown based on the mass body 130, the post 140, and the upper cap 150 that are formed by the filling process (seed layer is not shown).

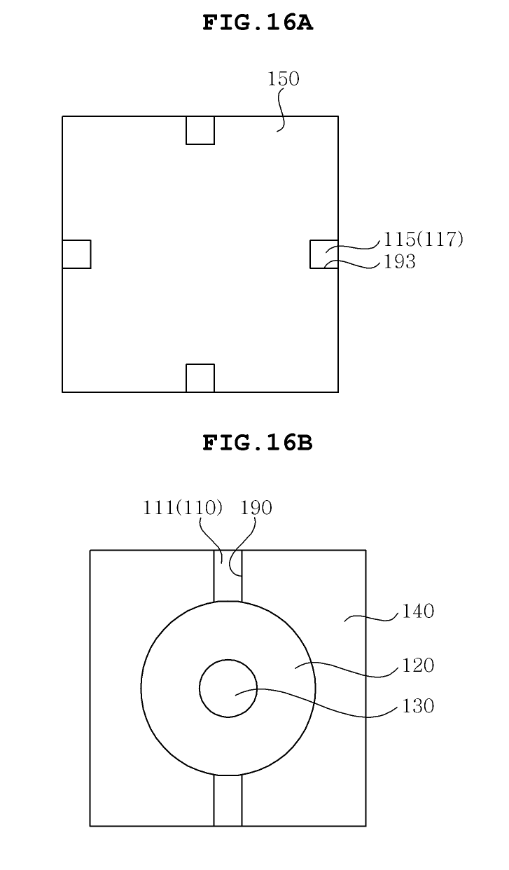

Meanwhile, since the first mold 120 and the second mold 125 is finally removed, the first through hole 190 (see FIG. 16B) and the second through hole 193 (FIG. 16A) may be provided at the post 140 and the upper cap 150 so that a portion of the first mold 120 and the second mold 125 is exposed to the outside. Describing the process of forming the first through hole 190 and the second through hole 193, the plating layer is formed by the plating process after the seed layer 180 is formed other than the portion in which the first through hole 190 and the second through hole 193 are formed, thereby forming the first through hole 190 and the second through hole 193. Alternatively, after the post 140 and the upper cap 150 are formed, the first through hole 190 and the second through hole 193 may be formed by laser or etching.

Since the mass body 130 formed by the present process is made of metal, the density of the mass body 130 may be increased and the mass body 130 may be formed to have the structure of the high aspect ratio, thereby improving the sensitivity of the inertial sensor 100. In addition, since the mass body 130 is formed using an inexpensive metal, the competitive price of the inertial sensor 100 may be secured.

In addition, since the upper cap 150 is formed by the plating process or the filling process, there is no need to perform a separate bonding process between the upper cap 150 and the membrane 110.

The following process is a process of forming the lower cap 170 using the third mold 160. The process of forming the lower cap 170 is very similar to a process of forming the above-mentioned mass body 130, the post 140, and the upper cap 150. Therefore, the difference will be mainly described and the repeated contents will be omitted.

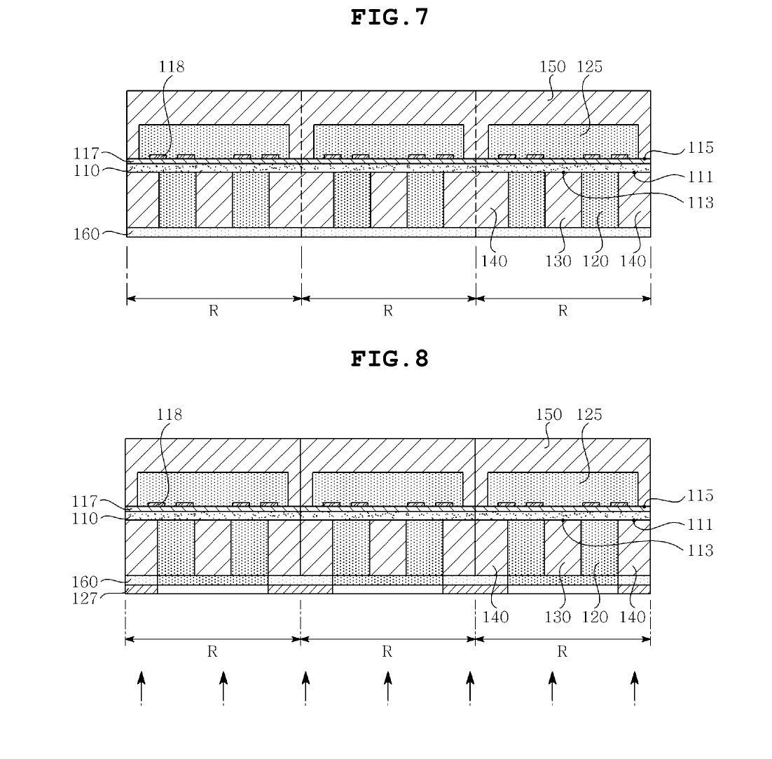

First, as shown in FIGS. 7 and 8, a process of optionally hardening third mold 160 by exposure is performed after the third mold 160 is applied to the post 140 and the exposed surface of the first mold 120, and the mass body 130. In this case, as the third mold 160, the photoresist having photosensitivity may be used.

The present process first applies the third mold 160 to the post 140 and the exposed surface of the first mold 120 and the mass body 130 and the baking process of removing a solvent within the third mold 160 is performed (see FIG. 7). Thereafter, when the artwork film 127 is exposed to ultraviolet rays (arrow) while closely contacting the third mold 160, the third mold 160 is optionally hardened (see FIG. 8). Since the post 140 is exposed during the following process, the present process optionally hardens only the portion corresponding to the first mold 120 and the mass body 130 in the third mold 160.

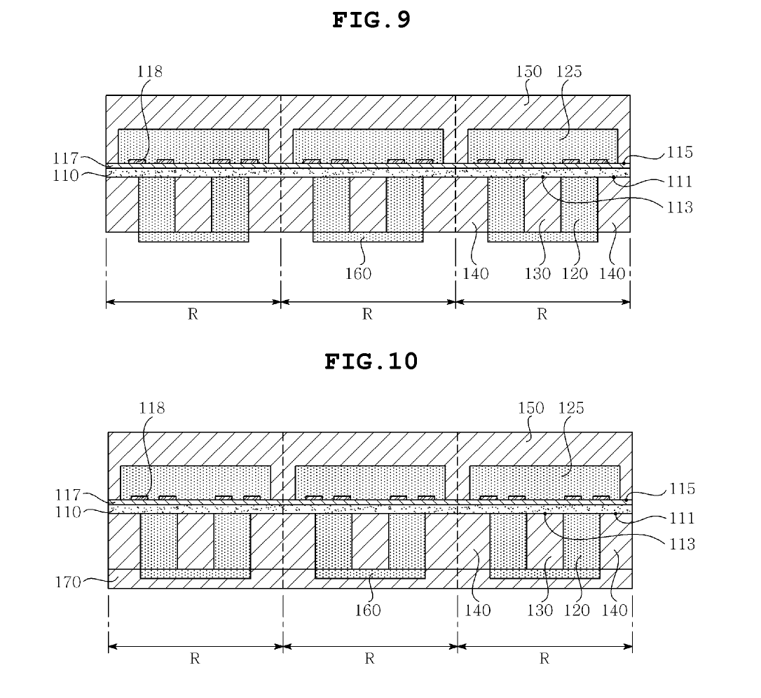

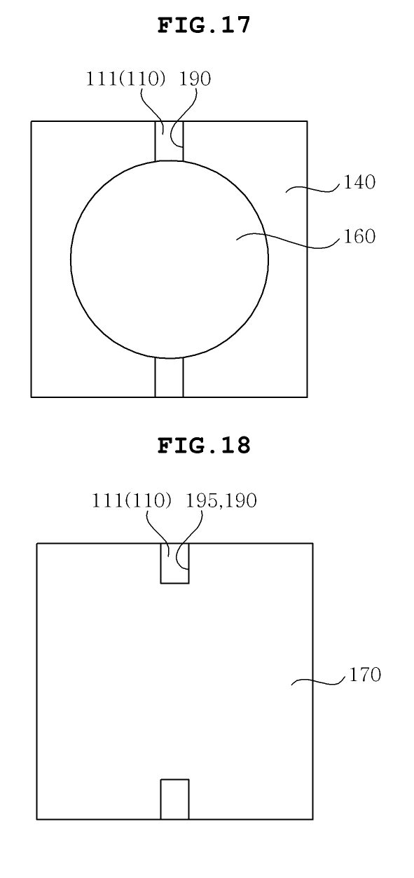

Next, as shown in FIGS. 9 and 17, a process of patterning the third mold 160 by a development is performed so as to expose the post 140. Since the third mold 160 is optionally hardened during the previous process, when the portion that is not hardened during the third mold 160 is removed by being dissolved by a developer such as sodium carbonate, potassium carbonate, or the like, the third mold 160 may be patterned. In this case, the third mold 160 may also be formed in a cylindrical shape (see FIG. 17), but is only an example. Therefore, the third mold 160 may be formed in various shapes according to the shape of the lower cap 170 to be formed.

Next, as shown in FIG. 10, a process of forming the lower cap 170 through the plating process or the filling process is performed.

In detail, the lower cap 170 may be formed by the plating process. The present process forms the lower cap 170 that extends from the post 140 to the exposed surface of the third mold 160 by performing the plating process. That is, when the lower cap 170 is formed, the plating process is performed so as to make the lower cap 170 thicker than the thickness of the third mold 160, such that the third mold 160 is completely surrounded with the plating layer. Meanwhile, the seed layer may be formed so as to give the conductivity prior to performing the plating process. However, since the post 140 has the conductivity, the seed layer is not necessarily formed.

In addition, the lower cap 170 may be formed by the filling process. In this case, the filling process, which fills the metal paste, forms the upper cap 150 that extends from the post 140 to the exposed surface of the third mold 160 by filling the metal paste. In this case, the third mold 160 is completely surrounded with the metal paste by performing the filling process so as to make the upper cap 150 thicker than the thickness of the third mold 160.

Meanwhile, since the third mold 160 is finally removed, a third through hole 195 may be provided at the lower cap 170 so as to expose the third mold 160 to the outside. In this case, the third through hole 195 formed on the lower cap 170 may correspond to the first through hole 190 formed at the post 140. This is to remove both of the second mold 125 and the third mold 160 while minimizing the formation area of the through hole. The process of forming the third through hole 195 is the same as the process of forming the first through hole 190.

Since the lower cap 170 formed through the present process is integrally configured so as to extend from the post 140, there is no need to perform the separate bonding process between the lower cap 170 and the post 140, such that the manufacturing process may be simplified and the manufacturing costs may be saved.

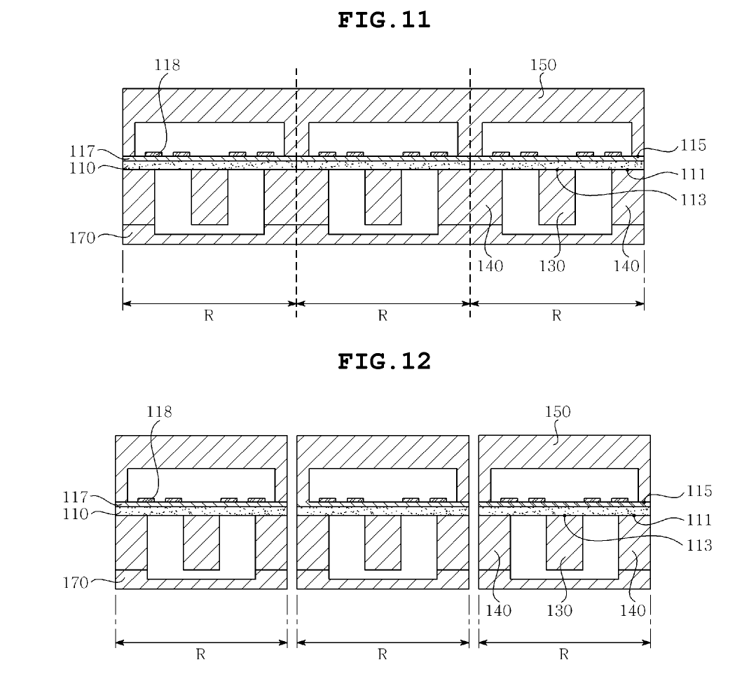

Next, as shown in FIG. 11, a process of removing the first mold 120, the second mold 125, and the third mold 160 is performed. Through the above-mentioned processes, since the formation of the mass body 130, the post 140, the upper cap 150, and the lower cap 170 completes, the present process is to remove the first mold 120, the second mold 125, and the third mold 160. The method of removing the first mold 120, the second mold 125, and the third mold 160 is not specifically limited and therefore, the first mold 120, the second mold 125, and the third mold 160 may be removed by a wet removing method or plasma ashing. The wet removing method uses H₂SO₄/H₂O₂ or an alkali solution, which may save costs. On the other hand, the plasma ashing oxidizes the first mold 120, the second mold 125, and the third mold 160 that are an organic material by the strong reactivity of active oxygen O generated within plasma so as to be discharged in a volatile gas type such as vapor H₂O and carbon dioxide CO₂. Using the plasma ashing may remove the first mold 120, the second mold 125, and the third mold 160 by a simple process and prevent the environmental pollution by preventing waste water from being discharged.

The first mold 120, the second mold 125, and the third mold 160 removed during the present process are discharged through the first through hole 190, the second through hole 193, and the third through hole 195.

Next, as shown in FIG. 12, a process of partitioning the membrane 110 along a boundary of the predetermined region R is performed. As described above, the predetermined region R is a region that finally configures the single inertial sensor 100. Therefore, when the single membrane 110 is partitioned into the plurality of predetermined region R, a process of partitioning the membrane 110 along the boundary of the predetermined region R to be separated into each inertial sensor 100 is performed. In this case, the process of partitioning the membrane 110 may be performed using a general diamond wheel. Meanwhile, when the membrane 110 is partitioned, the post 140, the upper cap 150, and the lower cap 170 may be partitioned together.

However, when the single inertial sensor 100 is manufactured by using the single membrane 110, the overall membrane 110 is partitioned into the single predetermined region R and therefore, the present process may be omitted.

Meanwhile, the inertial sensor 100 manufactured by the above-mentioned processes is configured to include the membrane 110, the mass body 130, the post 140, the upper cap 150, and the lower cap 170.

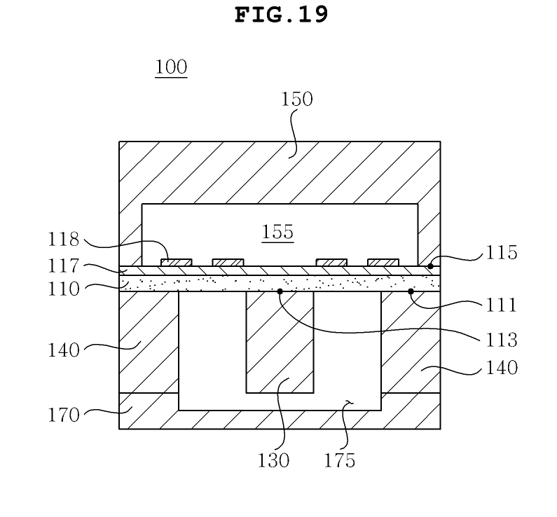

FIG. 19 is a cross-sectional view of the inertial sensor according to the preferred embodiment of the present invention. The inertial sensor 100 will be described in detail below with reference to FIG. 19.

The membrane 110 is formed in a plate shape and has elasticity so as to vibrate the mass body 130. In detail, the bottom portion of the central portion 113 of the membrane 110 is provided with the mass body 130, such that the displacement occurs in response to the motion of the mass body 130. In addition, the bottom portion of the edge 111 of the membrane 110 is provided with the post 140 to serve to support the central portion 113 of the membrane 110. Meanwhile, since the elastic deformation is made between the central portion 113 and the edge 111 of the membrane 110, the electrode 118 is disposed to vibrate the mass body 130 (vibration electrode) and a detector is disposed to measure the displacement of the mass body 130 (detection electrode).

The mass body 130 is displaced by the inertial force or the Coriolis force and the post 140 is formed in a hollow shape to support the membrane 110 to secure a space in which the mass body 130 may be displaced. In this case, the mass body 130 may be formed in, for example, a cylindrical shape and the post 140 may be formed in a square pillar in which a cavity of a cylindrical shape is formed in at a center thereof. That is, when being viewed from a transverse section, the mass body 130 is formed in a circular shape and the post 140 is formed in a square shape having a circular opening provided at the center thereof. However, the shape of the above-mentioned mass body 130 and the post 140 is only an example but is not limited thereto. Therefore, the mass body 130 and the post 140 may be in all the shapes known to those skilled in the art.

The upper cap 150 is provided on the top portion of the membrane 110 to serve to protect the top portion of the inertial sensor 100. In this case, when the mass body 130 is vibrated, the upper cap 150 may be formed with a first concave portion 155 corresponding to the central portion of the membrane 110 so as not to hinder the vibration of the membrane 110, wherein the first concave portion 155 is formed by the second mold 125 during the manufacturing process.

The lower cap 170 is provided on the bottom portion of the post 140 to serve to protect the bottom portion of the inertial sensor 100. Further, the lower cap 170 may be provided with a second concave portion 175 at a portion corresponding to the mass body 130 so as not to hinder the vibration of the mass body 130, wherein the second concave portion 175 is formed by the third mold 160 during the manufacturing process.

Meanwhile, the inertial sensor 100 according to the preferred embodiment of the present invention can increase the overall impact resistance and secure the structural stability of the inertial sensor 100 since all of the post 140, the upper cap 150, and the lower cap 170 are made of metal.

As set forth above, the preferred embodiment of the present invention can form the mass body with metal by the plating process or the filling process to increase the density of the mass body and form the mass body so as to have the structure of the high aspect ratio, thereby improving the sensitivity of the inertial sensor.

In addition, the preferred embodiment of the present invention can form the post, the upper cap, and the lower cap with metal by the plating process or the filling process, thereby increasing the overall impact resistance and securing the structural stability of the inertial sensor accordingly.

Further, the preferred embodiment of the present invention can form the upper cap and the lower cap by the plating process or the filling process, thereby simplifying the manufacturing process and saving the manufacturing costs without performing the bonding process as in the prior art.

Further, the preferred embodiment of the present invention can form the mass body with the relatively inexpensive metal, thereby securing the competitive price of the inertial sensor without forming the mass body by etching the silicon substrate as in the prior art.

Further, the preferred embodiment of the present invention can implement the ground by forming the mass body with the metal, thereby facilitating the control of voltage within the inertial sensor.

Although the embodiment of the present invention has been disclosed for illustrative purposes, it will be appreciated that a method of manufacturing an inertial sensor according to the invention is not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A method of manufacturing an inertial sensor, the method comprising:
(A) disposing a first mold at one surface of a predetermined region so as to expose an edge and a central portion of one surface of the predetermined region in a plate-shaped membrane;
(B) forming a mass body at the central portion of one surface of the predetermined region exposed from the first mold and forming a post at an edge of one surface of the predetermined region, through a plating process or a filling process; and
(C) removing the first mold.

2. The method as set forth in claim 1, wherein at the step (A), a second mold is disposed at the other surface of the predetermined region so as to expose an edge of the other surface of the predetermined region in the membrane,
at the step (B), an upper cap surrounding the second mold is formed by extending from the edge of the other surface of the predetermined region exposed from the second mold to the exposed surface of the second mold through the plating process or the filling process, and
at the step (C), the second mold is removed.

3. The method as set forth in claim 1, further comprising: after the step (B), disposing a third mold at the exposed surface of the first mold and the mass body so as to expose the post; and
forming a lower cap surrounding the third mold by extending from the post exposed from the third mold to the exposed surface of the third mold through a plating process or a filling process
wherein at the step (C), the third mold is removed.

4. The method as set forth in claim 1, wherein at the step (A), the first mold is applied to one surface of the predetermined region and then, a patterning is made by exposure and development, so as to expose the edge and the central portion of one surface of the predetermined region.

5. The method as set forth in claim 2, wherein at the step (A), the second mold is applied to the other surface of the predetermined region and then, a patterning is made by exposure and development, so as to expose the edge of other surface of the predetermined region.

6. The method as set forth in claim 3, wherein at the disposing of the third mold, the third mold is applied to the exposed surface of the post, the first mold and the mass body and then, patterning is made by exposure and development so as to expose the post.

7. The method as set forth in claim 1, wherein at the step (B), when the mass body and the post are formed by the plating process,
prior to the step (B), a seed layer is formed at the central portion of one surface of the predetermined region exposed from the first mold, the edge of one surface of the predetermined region and the side of the first mold.

8. The method as set forth in claim 2, wherein at the step (B), when the upper cap is formed by the plating process,
prior to the step (B), a seed layer is formed at the edge of the other surface of the predetermined region that are exposed from the second mold and the exposed surface of the second mold.

9. The method as set forth in claim 1, wherein at the step (B), when the mass body and the post are formed by the filling process,
the step (B) performs the filling process using a metal paste.

10. The method as set forth in claim 2, wherein at the step (B), when the upper cap is formed by the filling process,
the step (B) performs the filling process using the metal paste.

11. The method as set forth in claim 3, wherein at the forming of the lower cap, when the lower cap is formed by the filling process, the forming of the lower cap performs the filling process using the metal paste.

12. The method as set forth in claim 1, wherein at the step (C), the first mold is removed by a wet removing method or plasma ashing.

13. The method as set forth in claim 2, wherein at the step (C), the second mold is removed by the wet removing method or the plasma ashing.

14. The method as set forth in claim 3, wherein at the step (C), the third mold is removed by the wet removing method or the plasma ashing.

15. The method as set forth in claim 1, further comprising, prior to the step (A), forming a piezoelectric body and an electrode at the other surface of the predetermined region in the membrane.

16. The method as set forth in claim 1, further comprising, after the step (C), partitioning the membrane along a boundary of the predetermined region,
wherein at the step (A), the membrane is partitioned into a plurality of predetermined regions.
